(19) United States
(12) Patent Application Publication
(10) Pub. No.: US 2002/0002484 A1
(43) Pub. Date: Jan. 3, 2002

(54) Method for processing formation and sale of merchandise by means of a network

(75) Inventor: Masaru Sanada, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/892,533

(22) Filed: Jun. 28, 2001

(30) Foreign Application Priority Data
Jul. 3, 2000 (JP) 2000-201184

(51) Int. Cl. G06F 17/60

(52) U.S. Cl. 705/10; 705/1; 705/26

(57) ABSTRACT

The method for processing formation and sale of merchandise by means of a network according to the present invention includes an appeal for public subscription step for listening to the requests of an indefinite number of users via a network in the planning stage of the merchandise, a request collection step for forming groups of subscribers for the plan based on the requests, a classification step for classifying the images and features of the merchandise based on information collected in the request collection step, an image disclosure step for disclosing the images and the features of the merchandise via the network for each group, an agreement decision step for deciding agreement on various matters including the prices of the merchandise between the maker and the subscribers after the image disclosure step, a manufacture or formation step for manufacture or formation of the merchandise when an agreement is reached following the agreement decision, a progress status disclosure step for successively disclosing via the network the progress status for each milestone of the manufacture or formation step, and a merchandise sale step for selling the merchandise to the subscribers in the stage of completion of the merchandise.

### BACKGROUND OF THE INVENTION

1. Field of the Invention

The present invention relates to a method for processing formation and sale of merchandise by means of a network, and more particularly to a method for processing formation and sale of merchandise that can execute market research in parallel, during the period from planning to sale of merchandise, by means of a network employed by Internet or the like.

2. Description of the Prior Art

In the recent industrialized society, differentiation of merchandise is conspicuous, and planning of merchandise on individual basis is becoming the more important. In particular, a category of merchandise termed “mass produced merchandise” that is widely circulated in the society and is aimed at an indefinite number of persons is proving to be a factor that is depriving the will of people to purchase the merchandise because of the lack of differentiation from other similar merchandise.

For example, even the color of merchandise, that has identical function but is different in the individually preferred color, plays an important role of being an element of differentiation. In such a background, manufacture and sale of merchandise that take differentiation elements of the merchandise into consideration in the manufacturing stage will eventually lead one to a very profitable business when considering acquisition of customers and subsequent services to the users, though admittedly it involves a certain increase in the manufacturing cost.

To cite an example, personal computer that is manufactured presently by various makers has nearly the same hardware functions so that the differentiation elements for its circulation in the society is diversified, be it the color, the memory capacity, the cordless feature, the built-in camera, the novel shape, or the like of the machine.

In the meantime, on the part of the presenter of the merchandise, as soon as a planning for the merchandise begins, they conduct a market research for establishing visible differentiating elements for the merchandise to investigate what type of merchandise can be sold how many based on the result of the research.

In the conventional system which covers the period from planning to sale of merchandise as described in the above, the taste of the users is determined based solely on the judgment on the part of the maker, so that there has been a drawback in that the conventional users are forced to purchase certain types of the merchandise, though being unsatisfactory about either one or all of the maker's decisions, in view of the fact that the users' demands are diversified in response to the life style, the use environment, the individual taste, and the like.

Moreover, since the maker moves to the manufacture and sale of the merchandise only after its own research and analysis of the market trend, it has a disadvantage that an enormous amount of time is required for the period from the planning to the sale of the merchandise.

### BRIEF SUMMARY OF THE INVENTION

Object of the Invention

It is the object of the present invention to provide a method for processing formation and sale of merchandise by means of a network, which is capable of conducting research and analysis of the market to reduce the time from the planning to the sale of the merchandise while taking users' requests into consideration as much as possible.

### SUMMARY OF THE INVENTION

The method for processing formation and sale of merchandise by means of a network according to the present invention includes an appeal for public subscription step to solicit requests of an indefinite number of users via a network at the planning stage of the merchandise, a request collection step to form groups of subscribers for the plan based on the requests, a classification step to classify the images and the features of the merchandise based on the information collected in the request collection step, an image disclosure step to disclose the images and the features of the merchandise for each group via the network, an agreement decision step to decide an agreement with the subscribers on matters including the prices of the merchandise after the image disclosure step, a manufacture or formation step to carry out manufacture or formation of the merchandise upon agreement following the agreement decision step, a progress status disclosure step to disclose sequentially the progress status for each milestone of manufacture or formation step, and a sales step to sell the merchandise to the subscribers at the completion stage of the merchandise.

### BRIEF DESCRIPTION OF THE DRAWINGS

The above-mentioned and other objects, features and advantages of this invention will become more apparent by reference to the following detailed description of the invention taken in conjunction with the accompanying drawings, wherein:

FIG. 1 is an overall flow chart of the system from planning to shipping of merchandise for describing an embodiment of the present invention;

FIG. 2 is a connection diagram between the maker and the subscribers who contributed responses about the merchandise via the network as shown in FIG. 1;

FIG. 3 is a matrix diagram between the subscribers and the corresponding request items shown in FIG. 2;

FIG. 4 is a disclosed information diagram by the assembly of the merchandise shown in FIG. 3; and

FIG. 5 is a progress status diagram representing the relation between the manufacturing process for each type of the merchandise in FIG. 4 and the schedule.

### DETAILED DESCRIPTION OF THE INVENTION

The system of the present invention is one in which it solicits an indefinite number of persons about information relating to all aspects that constitute the merchandise, such as the function, form, and feature of the merchandise, that serve also as a market research instrument, via a network represented by Internet, in a series of work from planning to sale of the merchandise, and completes the merchandise based on the result of the information. Referring to the drawings, an embodiment of the present invention will be described in the following by taking a specific commodity called personal computer as an example, about the formation and sale processing of merchandise, and a system relating to the sale via a network and the personal computer as a tool.

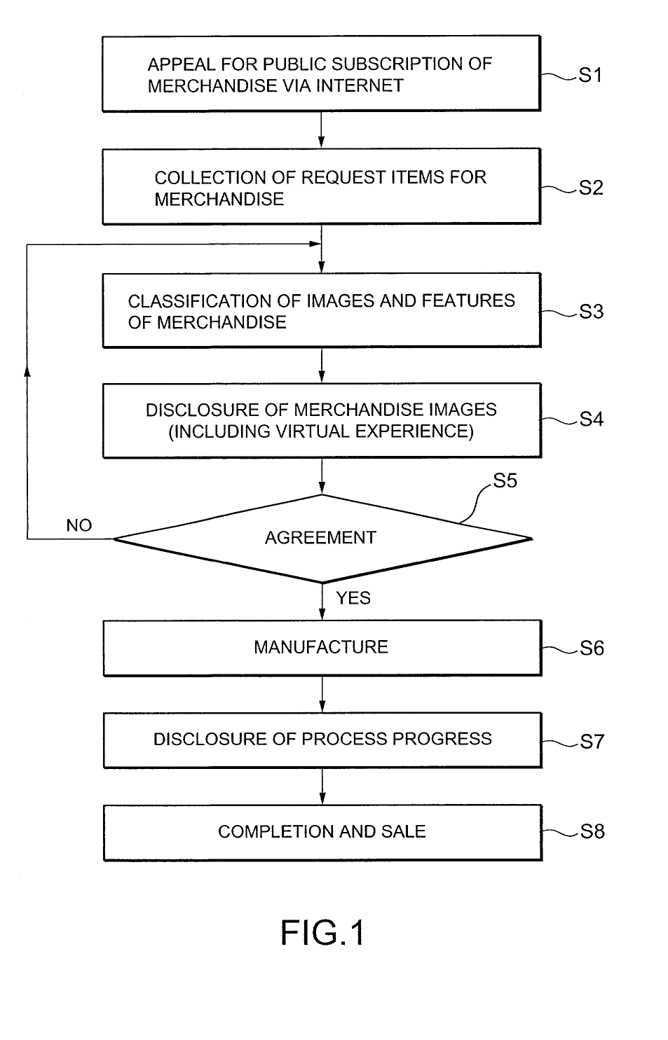

FIG. 1 is an overall flow chart of the system from planning to shipment of merchandise for describing an embodiment of this invention. In this embodiment, first, an appeal for public subscription is announced as to the planning of the merchandise (appeal for public subscription step S1) using a home page of the personal computer as a tool, as shown in FIG. 1 The appeal for public subscription step. S1 is a stage of merchandise planning on the part of the maker in which the maker designates the merchandise on the home page set by the maker, as well as listens to an indefinite number of requests about the merchandise via the network.

Next, the maker forms groups of subscribers (users) as to the planning for respective request items (request collection step S2), to classify the images and features of the merchandise (classification step S3).

Then, the maker discloses the image and the features of the merchandise for each group (image disclosure step S4). In the image disclosure step S4 the disclosure is made so as to permit virtual experience of the user who desires it.

Next, an agreement on the images and features including the prices of the merchandise is decided between the maker and the subscribers (agreement decision step S5). In the agreement decision step S5, exchange of opinions as to the merchandise for which public subscription was appealed is continued between the maker and the users until either the users reach an agreement to purchase or not to purchase the merchandise or a certain acceptable compromise is found.

When an agreement including an acceptable compromise is reached in the agreement decision step S5, manufacture of the merchandise is started (manufacturing step S6), and the progress status for each milestone of the manufacturing process is disclosed in succession (progress status disclosure step S7). Finally, with the completion of manufacture of the merchandise (completion and sales step S8), the maker ships out the merchandise to the subscribers via the network.

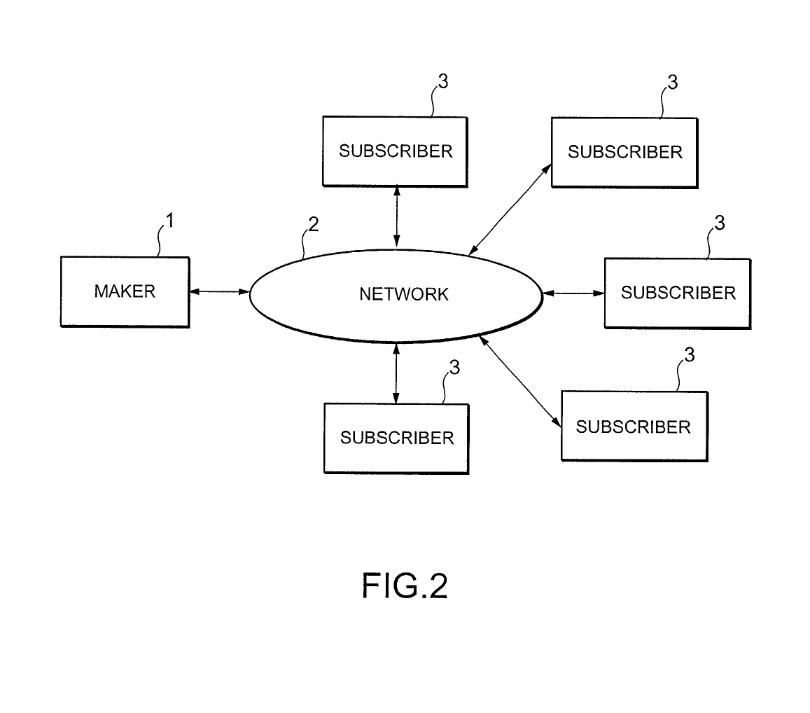

FIG. 2 is a connection diagram between the maker and the subscribers who made responses with the maker via the network as to the merchandise shown in FIG. 1. As shown in FIG. 2, host computer of the maker 1 is connected to a plurality of subscribers (users) 3 via the network 2 used in Internet. In this way, the host computer of the maker 1 inquires, via the network 2, indefinite number of persons about request items as to the merchandise called personal computer in the form of a questionnaire or desired demands via the network 2. As a result, request items from respective members of a plurality of subscribers (users) 3 are collected.

First, the maker 1 solicits indefinite number of persons to participate through the network in the investigation by a questionnaire and express their desired demands as to the hardware and software, such as the form, function, color, and the type of installed software, that constitute the personal computer in the planning of the personal computer. Subsequently, the maker designs images of the personal computer based on the collected contents, and discloses the design information to the subscribers 3. Responses obtained via the network 2 during this stage are classified by item, and a group of the applicants 3 is formed for each item. Responses corresponding to respective items are given to respective members of the groups, and merchandise images for respective items are shaped up.

There are two kinds in these response contents. One is the content in which items of investigation are list up according to the planned design on the part of the maker 1, variation items are selected in advance to the extent that permits the manufacture on the part of the maker 1, and the items are investigated by a questionnaire on Internet. The other is the content in which a rough policy on the plan is presented through Internet, and various requests of the customers concerning the content are accepted. In addition, opinions on an arbitrary individual request are also accepted.

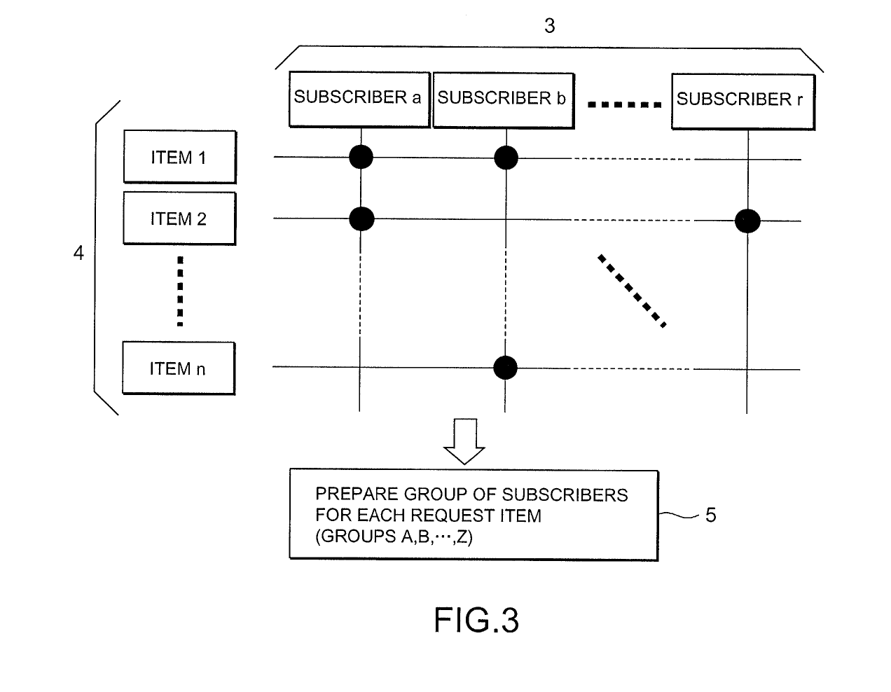

FIG. 3 is a matrix diagram of the request items versus subscribers who requested these items in FIG. 2. As shown in FIG. 3, the result obtained as an end product of the responses described above is classified into n request items 4 on the part of the maker 1, and groups of subscribers 3 are formed for respective request items. It is preferable that the scale of this classification is made as fine as possible. In the figure, the solid circle painted black at the intersection of the matrix of the request item 4 and the subscriber 3 represents the case that there exists a relevance between them, whereas the absence of the mark represents the case that there exists no such a relevance. As a result, a subscriber group information file 5 which is represented as groups of A to Z for the merchandise called personal computer is prepared in this manner.

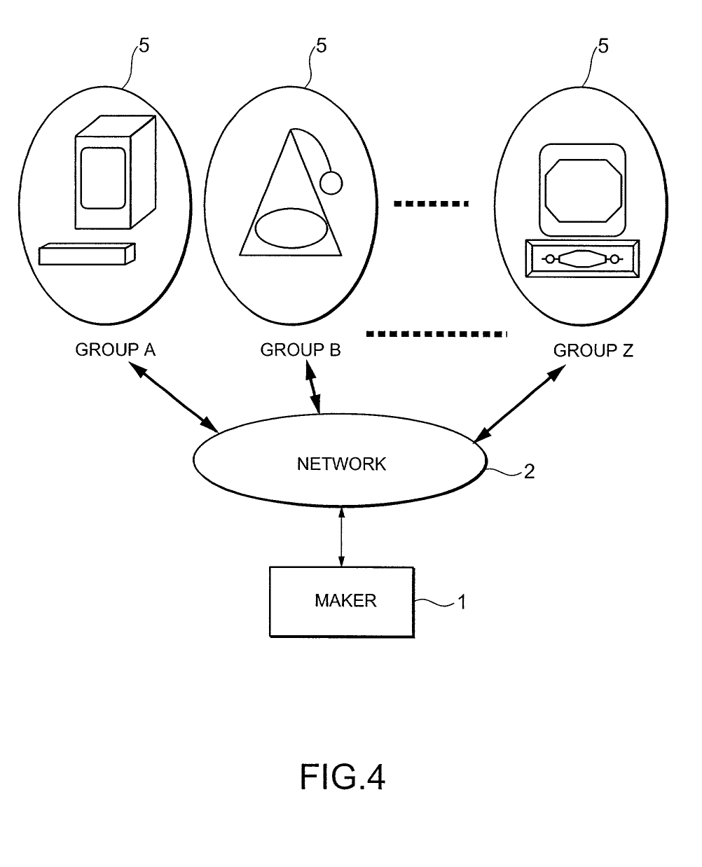

FIG. 4 is a disclosed information diagram for each assembly of the merchandise shown in FIG. 3. As shown in FIG. 4, in this stage, the image, properties, features, or the like of the merchandise are examined for each classification on the part of the maker 1. Then, after determination of the basic image for the merchandise, the image and the features for each classification content are allocated to the basic image, and the result is transferred to the relevant subscribers 3 as a subscriber group information file 5. In other words, the result is disclosed to each subscriber 3, and the opinions are collected by means of responses via the network 2. Exchange of opinions on these contents is continued until an agreement is reached or an acceptable compromise is found.

In this stage, the images disclosed on the part of the maker 1 are images that make a full use of computer graphic (CG), and are pieces of information that can be experienced virtually to the extent possible. Moreover, the prices of the merchandise are transmitted in this stage.

In particular, the virtual experience whether the place of installment, manner of use, harmony with the surroundings, and the like of the personal computer are effective to the subscribers 3 is an important verification step that can be experienced by simulation. Although such an experience may be undertaken by the subscriber himself, in case an experience on the part of the subscriber 3 is difficult, it is also possible to ask the maker 1 to construct a simulated experience by sending in the use environment data from the subscriber 3 to the maker 1 via the network 2, and let the subscriber 3 to check the simulated experience.

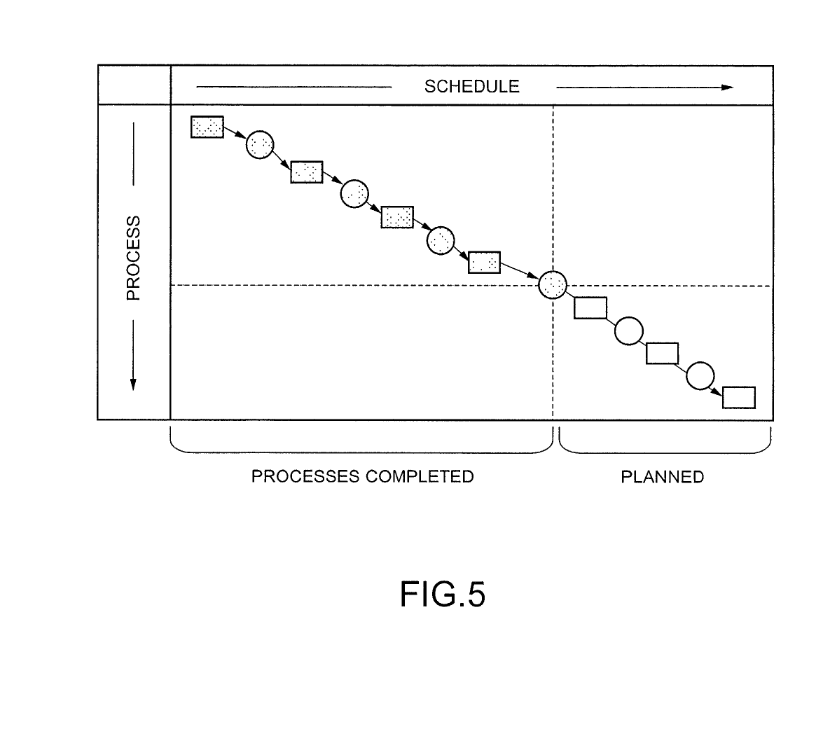

FIG. 5 is a progress status chart representing the relation between the manufacturing process for each type of merchandise shown in FIG. 4 and the schedule. As shown in FIG. 5, as soon as the image for each item is determined, the progress status in the stage of merchandise manufacture is reported to the subscriber 3, and an official completion date and the price of the merchandise are displayed. For example, the already completed processes and the manufacturing schedule, and the future plan are informed to the subscriber 3 as the progress status of the manufacturing stage. However, it is conceivable that a change in the specifications may be proposed by a subscriber 3 during the manufacturing stage of the merchandise. In such a case, the image is changed to a product that is estimated to be completed as of the date of the proposal, and it is possible to supply a differentiated merchandise by finding an acceptable compromise.

For the eventually completed merchandise, investigation on advantages, disadvantages, or the like of the merchandise by the purchasers are conducted, and the data obtained by the investigation are applied to the subsequent designs of the merchandise.

In this manner, it is possible to supply merchandise differentiated by the customers in satisfactory form by utilizing a system via Internet. Moreover, in the viewpoint of the maker 1, it is possible to take a unique market research into consideration, and reduce the time and man-hours needed for the period from planning to sale of the merchandise.

In the above, description has been given about a system involving a tangible merchandise of a personal computer. However, the present invention is equally applicable to an intangible merchandise. For example, for an intangible merchandise represented by a travel plan, a basic information and a planned advertisement are disclosed via Internet. Opinions and plans (for example, desired places of travel, accommodations, meals, cost, means of transportation, season, or the like) from an indefinite number of persons who support the plan are presented. The collected data are classified and plans for individual themes are configured. Then, the plans are disclosed to respective objective subscribers, and exchange of opinions from both sides is continued via Internet until an agreement is reached or an acceptable compromise is found. Upon reaching an agreement, planning and designing side determines the final merchandise and starts to sell the intangible merchandise to the subscribers.

In the two examples described in the above, regarding the design for planning on the part of the maker, it is important to collect in advance such pieces of information as the reliability, quickness of response, distance, and communication means of the party responsible for actualization of the merchandise, in order to be able to make full use of these pieces of information, regardless of the plan designer being its own company or a contractor.

Moreover, in the two examples in the above, the design for merchandise planning may be accomplished by making a full use of every kind of information collection means, such as appeal for public subscription through newspapers, retrieval of market trend by means of investigation using questionnaires, mailing of advertising documents, collection of opinions by hearing, or the like.

As described in the above, the method for processing formation and sale of merchandise by means of a network according to this invention, makes it possible to supply merchandise that depends on individual taste, based on the mutual understanding between the maker and the users, through repeated exchange of opinions between both parties via the network for Internet. This method permits response at free times, and has an effect that it enables an instantaneous response at anyplace between the plan designer (maker) and the customer (user).

Moreover, in the viewpoint of the maker, the method of the present invention has an effect that can enhance the feeling of satisfaction of the customers, since it is possible to supply merchandise based on the product specifications differentiated by the requests of the customers, and the time schedule from the planning stage of the merchandise to its manufacture and shipping is displayed publicly. In addition, this invention has an effect in which supply of merchandise unsatisfactory to the customers can be prevented, an enormous advertisement cost can be cut drastically, and realization of exploration of new customers and prevention of manufacture of useless product can be achieved, as well as flexible handling of changes in the features and images of the merchandise on its way to the manufacture can be realized.

Furthermore, in the viewpoint of the maker, the present invention has an effect that it is possible to extract dissatisfaction on the part of the customers that has not been made public in the past, and since it is possible to view the appearance of the merchandise and undergo simulation experience prior to the purchase of the merchandise, the environment and constitution accompanying the merchandise can be prepared in advance.

Although the invention has been described with reference to a specific embodiment, this description is not meant to be construed in a limiting sense. Various modifications of the disclosed embodiment will become apparent to persons skilled in the art upon reference to the description of the invention. It is therefore contemplated that the appended claims will cover any modifications or embodiments as fall within the true scope of the invention.

What is claimed is:

1. A method for processing formation and sale of merchandise by means of a network comprising: an appeal for public subscription step for listening to the requirements of an indefinite number of users via a network in the planning stage of merchandise, a request collection step for forming groups of subscribers for the plan based on said requirements, a classification step for classifying the images and the features of the merchandise based on the collected information in said request collection step, an image disclosure step for disclosing the image and features of said merchandise for each of said group via said network, an agreement decision step for deciding an agreement on various aspects of the merchandise including its prices between the maker and said subscribers following said image disclosure step, a manufacture or formation step for executing manufacture or formation of said merchandise upon establishment of an agreement following said agreement decision step, a progress status disclosure step for disclosing via said network the progress status for each milestone of successive manufacture or formation steps, and a sale step for selling said merchandise to said subscribers in the stage of completion of said merchandise.

2. The method for processing formation and sale of merchandise by means of a network as claimed in claim 1, wherein said appeal for public subscription step in the planning stage of said merchandise collets requests of individuals that include annoying problems concerning said merchandise and information which make the merchandise more attractive, in listening to requests of said indefinite number of users.

3. The method for processing formation and sale of merchandise by means of a network as claimed in claim 1, wherein said image disclosure step forms said merchandise image using images, features and properties that cover comprehensively the information having contents that satisfy the requests from said indefinite number of users.

4. The method for processing formation and sale of merchandise by means of a network as claimed in claim 1, wherein said merchandise image in said appeal for public subscription step is formed using computer graphic, and finds an agreement or an acceptable compromise after disclosure and mutual exchange of views via said network.

5. The method for processing formation and sale of merchandise by means of a network as claimed in claim 1, wherein said image disclosure step conducts simulation experiment for said merchandise with respect to both of hardware and software.

6. The method for processing formation and sale of merchandise by means of a network as claimed in claim 1, wherein said manufacture or formation step and said progress status disclosure step disclose the manufacture or formation process of said merchandise, and when a request for specification change arises from said subscriber, the original image is changed to a completed image estimated as of the date of the request, to disclose the estimated result, and differentiation is effected by finding an acceptable compromise.
